(19) United States
(12) Patent Application Publication
(10) Pub. No.: US 2016/0328867 A1
(43) Pub. Date: Nov. 10, 2016

(54) METHOD AND APPARATUS FOR PERFORMING CURVE RENDERING

(71) Applicant: Samsung Electronics Co., Ltd., Suwon-si (KR)

(72) Inventors: Jaedon LEE, Yongin-si (KR); Jeongjoon YOO, Hwaseong-si (KR)

(73) Assignee: Samsung Electronics Co., Ltd., Suwon-si (KR)

(21) Appl. No.: 14/959,238

(22) Filed: Dec. 4, 2015

(30) Foreign Application Priority Data
May 7, 2015 (KR) 10-2015-0063881

(51) Int. Cl. G06T 11/20; G06T 1/20

(52) U.S. Cl. CPC G06T 11/203; G06T 1/20

(57) ABSTRACT

An apparatus and a method of performing curve rendering are provided. A method of performing curve rendering involve determining a plurality of points based on a shape of a curve by using a processor, forming at least one triangle based on a location relationship between the plurality of points, and shading pixels corresponding to the curve by using the at least one triangle, in which the plurality of points are vertices of the at least one triangle.

### CROSS-REFERENCE TO RELATED APPLICATION(S)

This application claims the benefit under 35 USC 119(a) of Korean Patent Application No. 10-2015-0063881, filed on May 07, 2015, in the Korean Intellectual Property Office, the entire disclosure of which is incorporated herein by reference for all purposes.

### BACKGROUND

1. Field

The following description relates to a method and an apparatus for performing curve rendering.

2. Description of Related Art

Recently, researches have been conducted to accelerate the performance of a graphics processing unit (GPU) for vector graphics or path rendering has been recently conducted. To accelerate the performance of three-dimensional (3D) graphics hardware, the hardware structure of the GPU is designed on the assumption that all input data is formed of vertices of triangles. However, in the case of path rendering, the input data is not formed of the vertices of a triangle, but of a combination of commands and vertices. Therefore, when path rendering is performed, it is difficult to improve the acceleration performance of the GPU.

For example, in order to draw a curve by using the GPU, a central processing unit (CPU) divides the curve into a plurality of triangles based on a start point of the curve, and the obtained triangles are transformed into curves by using OpenGL API. The process performed by the CPU to divide a curve into a plurality of triangles may be time consuming. Further, whenever a large number of OpenGL APIs are called, the Open GL APIs have to communicate with the GPU, which also increase the overall time for curve rendering. In addition, many state changes of the GPU take place during the curve rendering.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Provided are methods and apparatuses for performing curve rendering. Also, provided is a computer-readable recording medium having recorded thereon a computer program for executing the method in a computer.

In one general aspect, a method of performing curve rendering involve determining a plurality of points based on a shape of a curve by using a processor, forming at least one triangle based on a location relationship between the plurality of points, and shading pixels corresponding to the curve by using the at least one triangle, in which the plurality of points are vertices of the at least one triangle.

The plurality of points may include first points corresponding to the curve and a second point calculated based on the first points.

The curve may include a cubic Bézier curve. In the determining of the plurality of points, four first points corresponding to the cubic Bézier curve may be determined as the plurality of points. In the forming of the at least one triangle, three of the four first points may be vertices of the at least one triangle, and the other of the four first points may be positioned within the at least one triangle.

The curve may include a cubic Bézier curve. In the determining of the plurality of points, four first points corresponding to the cubic Bézier curve may be determined as the plurality of points. In the forming of the at least one triangle, the at least one triangle may be formed based on a location of a segment connecting two of the four first points and respective locations of the other two of the four first points.

The curve may include a curve including a cusp. In the determining of the plurality of points, four first points corresponding to the curve comprising the cusp and a second point corresponding to the cusp may be determined as the plurality of points. In the forming of the at least one triangle, the curve including the cusp may be positioned within a triangle of which vertices are two of the four first points and the second point.

The curve may include a curve including a loop. In the determining of the plurality of points, four first points corresponding to the curve may include the loop and a second point corresponding to an intersection point where portions of the curve comprising the loop intersect are determined. In the forming of the at least one triangle, the curve including the loop may be positioned within a triangle of which vertices are two of the four first points and the second point.

The shading of the pixels may include setting colors of the pixels corresponding to an inside area of the curve from among pixels comprised in the at least one triangle.

In another general aspect, a non-transitory computer-readable storage medium storing instructions to cause computing hardware to perform a general aspect of the method described above is provided.

In another general aspect, a device for performing curve rendering may include a determination processor configured to determine a plurality of points based on a shape of a curve, a formation processor configured to form at least one triangle based on a location relationship between the plurality of points, and a shading processor configured to shade a plurality of pixels corresponding to the curve based on the at least one triangle, in which the plurality of points are vertices of the at least one triangle.

The plurality of points may include first points corresponding to the curve or a second point calculated based on the first points.

The curve may be a cubic Bézier curve. The determination processor may be configured to determine four first points corresponding to the cubic Bézier curve. The formation processor may be configured to form the at least one triangle of which vertices are three of the four first points, and the other of the four first points may be positioned within the at least one triangle.

The curve may be a cubic Bézier curve. The determination processor may be configured to determine four first points corresponding to the cubic Bézier curve, and the formation processor may be configured to form the at least one triangle based on a location of a segment connecting two of the four first points and respective locations of the other two of the four first points.

The curve may be a curve including a cusp. The determination processor may be configured to determine four first points corresponding to the curve including the cusp and a second point corresponding to the cusp. The formation processor may be configured to form a triangle of which vertices are two of the four first points and the second point such that the curve comprising the cusp is positioned within the triangle.

The curve includes a curve including a loop. The determination processor may be configured to determine four first points corresponding to the curve comprising the loop and a second point corresponding to an intersection point where portions of the curve comprising the loop intersect. The formation processor may be configured to form two triangles of which vertices are two of the four first points and the second point such that the curve including the loop is positioned within the two triangles. The two of the four points may be different for each of the triangles.

The general aspect of the device may further include a shading unit configured to set colors of pixels corresponding to an inside area of the curve from among pixels in the at least one triangle.

In another general aspect, an apparatus for performing curve rendering includes a central processing unit (CPU) configured to determine a plurality of points based on a shape of a curve and form at least one triangle based on a location relationship between the plurality of points, and a graphics processing unit (GPU) configured to shade pixels corresponding to the curve based on the at least one triangle, and the plurality of points are vertices of at least one triangle.

In another general aspect, an apparatus for performing curve rendering includes a central processing unit (CPU) configured to determine a plurality of points based on a shape of a curve and generate data corresponding to at least one triangle based on a location relationship between the plurality of points; and a graphics processing unit (GPU) configured to form the at least one triangle by using the generated data and shade a plurality of pixels corresponding to the curve by using the at least one triangle, and the plurality of points are vertices of the at last one triangle.

In yet another general aspect, a method of performing curve rendering involves determining a plurality of points based on a shape of a curve by using a determination processor of a rendering device, forming at least one triangle based on a location relationship between the plurality of points by inputting the plurality of points into a formation processor of the rendering device, and determining pixels corresponding to the curve based on the at least one triangle.

The pixels may correspond to pixels of a display.

The determining of the pixel may be performed by a shading processor of the rendering device by calculating a Bézier curve based on the plurality of points.

The determining of the pixel may be performed by a graphics processing unit including an electronic circuit for calculating the pixels of a display that corresponds to a curve and a frame buffer configured to output information regarding the pixels to the display.

Other features and aspects will be apparent from the following detailed description, the drawings, and the claims.

### BRIEF DESCRIPTION OF THE DRAWINGS

FIG. 1 is a diagram illustrating an example of a rendering device.

FIGS. 2A to 2D are diagrams illustrating examples of cubic Bézier curves.

FIG. 3 is a flowchart of an example operation of a rendering device.

FIG. 4 is a flowchart illustrating an operation of a determination processor and a formation processor according to an example of a rendering device.

FIGS. 5A to 5B are diagrams illustrating an operation of a determination processor and a formation processor according to the example illustrated in FIG. 4.

FIG. 6 is a flowchart illustrating an operation of a determination processor and a formation processor according to another example of a rendering device.

FIGS. 7A to 7B are diagrams illustrating an operation of a determination processor and a formation processor according to the example illustrated in FIG. 6.

FIG. 8 is a flowchart illustrating an operation of a determination processor and a formation processor according to another example of a rendering device.

FIG. 9 is a diagram illustrating an operation of a determination processor and a formation processor according to the example illustrated in FIG. 8.

FIG. 10 is a flow chart illustrating an operation of a determination processor and a formation processor according to another example of a rendering device.

FIG. 11 is a diagram illustrating an operation of a determination processor and a formation processor according to the example illustrated in FIG. 10.

FIG. 12 illustrates a flowchart of an operation of a determination processor and a formation processor according to another example of a rendering device.

FIG. 13 is a diagram illustrating an example of a rendering apparatus.

FIG. 14 is a diagram illustrating an example of a rendering apparatus.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

The terms used in this specification are those general terms currently widely used in the art in consideration of functions regarding the inventive concept, but the terms may vary according to the intention of those of ordinary skill in the art, precedents, or new technology in the art. Also, specified terms may be selected by the applicant, and in this case, the detailed meaning thereof will be described in the detailed description of the inventive concept. Thus, the terms used in the specification should be understood not as simple names but based on the meaning of the terms and the overall description.

Throughout the specification, when a portion “includes” an element, another element may be further included, rather than excluding the existence of the other element, unless otherwise described. Also, the terms “. . . unit”, “. . . module”, etc. are units for processing at least one function or operation and may be implemented as hardware, software, or a combination of hardware and software, including a processor and a memory.

Various examples will now be described more fully with reference to the accompanying drawings. The examples may, however, be embodied in many different forms and should not be construed as being limited to the embodiments set forth herein; rather, these examples are provided so that this disclosure will be thorough and complete, and will fully convey the concept to those skilled in the art.

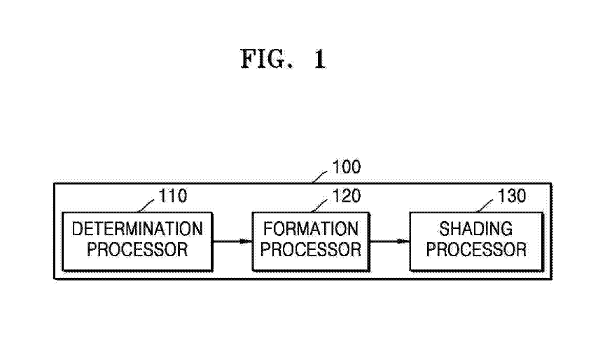

FIG. 1 illustrates a block diagram of an example of a rendering device.

Referring to FIG. 1, the rendering device 100 include a determination processor 110, a formation processor 120, and a shading processor 130.

The rendering device 100 performs rendering of a curve to create a digital file corresponding to a 2D image, a 3D image or a motion picture, or to display an image on a display. The curve is a target for which rendering is performed and may correspond to an entire object or a portion of the object to be output on a screen. In other words, the object is formed of at least one edge or curve, and as the edge or curve is rendered, the object may be output on the screen.

Edges connecting two different vertices only have a length difference and have the same shape. However, a curve formed based on at least two control points may have various shapes according to locations or the control points or the number of control points.

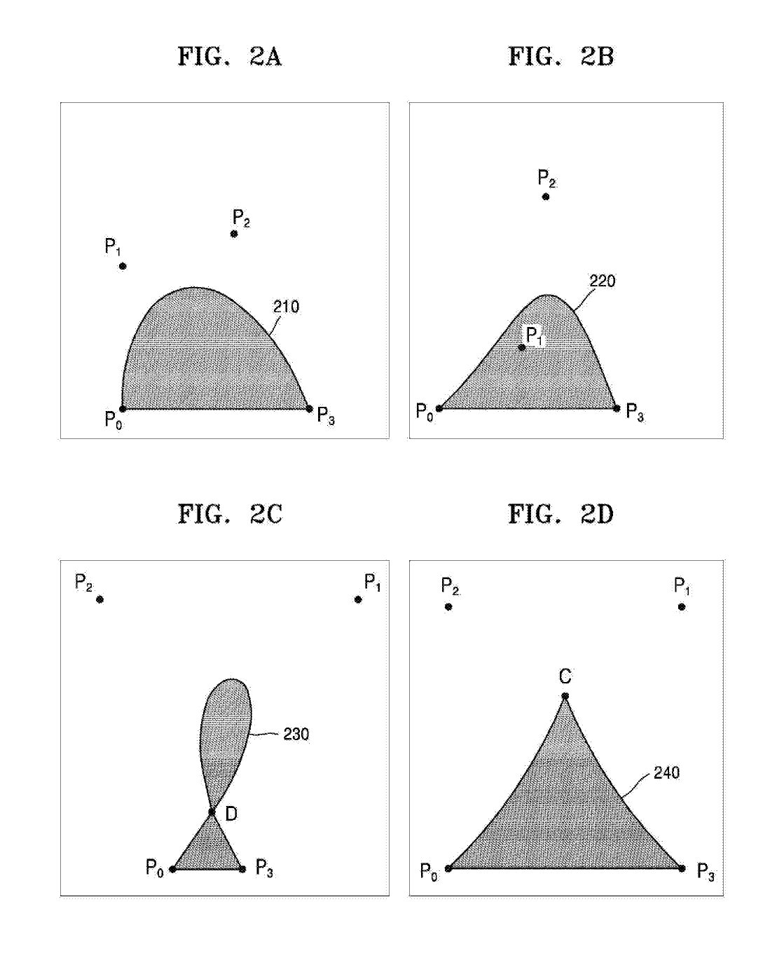

For example, the cubic Bézier curve formed based on four control points may include a cusp or loop according to locations of control points. Hereinafter, examples of the cubic Bézier curve will be described with reference to FIGS. 2A to 2D.

FIGS. 2A to 2D illustrate examples of cubic Bézier curves 210, 220, 230, and 240 according to an embodiment.

The cubic Bézier curves 210, 220, 230, and 240 are determined by four different control points. In other words, if locations (e.g., the coordinates) of the control points are identified, shapes of the cubic Bézier curves 210, 220, 230, and 240 may be determined. For example, the cubic Bézier curves 210, 220, 230, and 240 may be determined by the following Equation 1.

B(t)=(1−t)³P₀+3(1−t)²tP₁+3(1−t)t²P₂+t³P₃, t∈[0,1], [Equation ]

In the above Equation 1, B(t) indicates the cubic Bézier curves 210, 220, 230, and 240, and P0, P1, P2, and P3 respectively indicate control points. Also, t is a number between 0 and 1.

FIGS. 2A to 2D illustrate examples of shapes of the cubic Bézier curves 210, 220, 230, and 240 according to locations of the control points P0, P1, P2, and P3. In this example, the shapes of the cubic Bézier curves 210, 220, 230, and 240 are determined according to locations of the control points P1 and P2 except the control point P0 corresponding to a staring vertex of the cubic Bézier curves 210, 220, 230, and 240 and the control point P3 corresponding to an end point of the cubic Bézier curves 210, 220, 230, and 240.

Referring to FIG. 2A, the control points P1 and P2 are positioned in an outer area of the cubic Bézier curve 210. In other words, all of the control points P0, P1, P2, and P3 are in contact with the cubic Bézier curve 210 or are positioned in the outer area of the cubic Bézier curve 210. Therefore, the cubic Bézier curve 210 may have a gently-curved convex shape.

Referring to FIG. 2B, the control point P1 is positioned in an inner area of the cubic Bézier curve 220, and the control point P2 is positioned in an outer area of the cubic Bézier curve 220. Therefore, a portion of the cubic Bézier curve 220 is curved inwardly toward the point P1.

Referring to FIG. 2C, the control point P1 is positioned to the right of the control point P2. Compared with the control points P1 and P2 on the cubic Bézier curve 210 of FIG. 2A, the control points P1 and P2 are also positioned in an outer area of the cubic Bézier curve 230, but locations of the control points P1 and P2 are reversed. Therefore, the cubic Bézier curve 230 may have a shape including a loop.

Referring to FIG. 2D, the control point P1 is positioned to the right of the control point P2. Locations of the control points P1 and P2 are identical with the locations of the control points P1 and P2 on the cubic Bézier curve 230 of FIG. 2C. However, according to a value of t in Equation 1, although the locations of the control points P1 and P2 are identical with the locations of the control points P1 and P2 on the cubic Bézier curve 230, types of a curve may be divided into the cubic Bézier curve 230 including a loop or the cubic Bézier curve 240 including a cusp.

In general, rendering of the cubic Bézier curves 210, 220, 230, and 240 is performed after a triangle is formed by using the control points P0, P1, P2, and P3 and then pixels corresponding to the cubic Bézier curves 210, 220, 230, and 240 are shaded based on the formed triangle. In this case, in the case of the cubic Bézier curve 210 of FIG. 2A, when two triangles are formed by using the control points P0, P1, P2, and P3, the cubic Bézier curve 210 may be fully included in the formed triangles. However, in the case of the cubic Bézier curves 220, 230, and 240 of FIGS. 2B to 2D, the cubic Bézier curves 220, 230, and 240 may not be fully included in the triangles formed by using the control points P0, P1, P2, and P3. Therefore, the cubic Bézier curves 220, 230, and 240 are divided into a plurality of sub-curves, and then triangles respectively corresponding to the sub-curves are formed. Accordingly, a computational amount of the rendering device 100 increases, and thus the performance thereof may degrade.

The rendering device 100 according to an embodiment performs curve rendering without dividing a curve into a plurality of sub-curves. Therefore, in comparison with a general rendering process, a computational amount of the rendering device 100 to perform curve rendering may decrease, and a high-quality rendering result may be output.

Referring back to FIG. 1, the determination processor 110 determines points based on a shape of a curve. The points include the control points described with reference to FIGS. 2A to 2D and points determined according to a shape of a curve. For example, if it is assumed that the curve includes a loop, the determination processor 110 may determine as points four control points of the curve as well as an intersection point where portions of the curve intersect each other. As another example, when it is assumed that the curve includes a cusp, the determination processor 110 may determine, as points, four control points corresponding to the curve as well as a point corresponding to the cusp.

The formation processor 120 forms at least one triangle based on a location relationship between the points. In other words, the formation processor 120 may form at least one triangle in consideration of locations between the points determined by the determination processor 110. In this case, the at least one triangle has points as vertices.

The shading processor 130 shades pixels corresponding to the curve by using a triangle. In detail, the shading processor 130 sets colors of pixels corresponding to an inside of the curve from among the pixels included in the triangle.

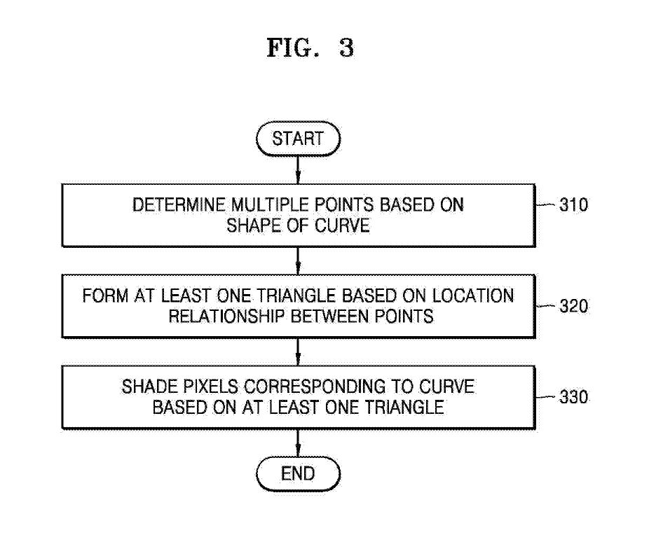

Hereinafter, examples of operations of the rendering device 100 will be described in detail with reference to FIGS. 3 to 14.

FIG. 3 illustrates a flowchart of an example of an operation of a rendering device 100.

In operation 310, the determination processor 110 determines a plurality of points based on a shape of a curve. For example, the determination processor 110 may identify the shape of the curve based on curve data and may determine the points according to the identified shapes of the curve. The curve data includes information indicating locations of control points corresponding to the curve, a length of the curve, and the like. The curve data may be generated by the determination processor 110 or may be received from an external device.

Also, a point determined according to the shape of the curve may be further included in the points determined by the determination processor 110, other than the control points. In other words, the determination processor 110 may acquire the control points corresponding to the curve and may calculate other points by using respective coordinates of the control points.

In operation 320, the formation processor 120 may form at least one triangle based on a location relationship between the points. For example, the formation processor 120 may generate a triangle used for rendering in accordance with an order of the points and locations of the points in a frame. Vertices of the triangle are formed as the points determined by the determination processor 110.

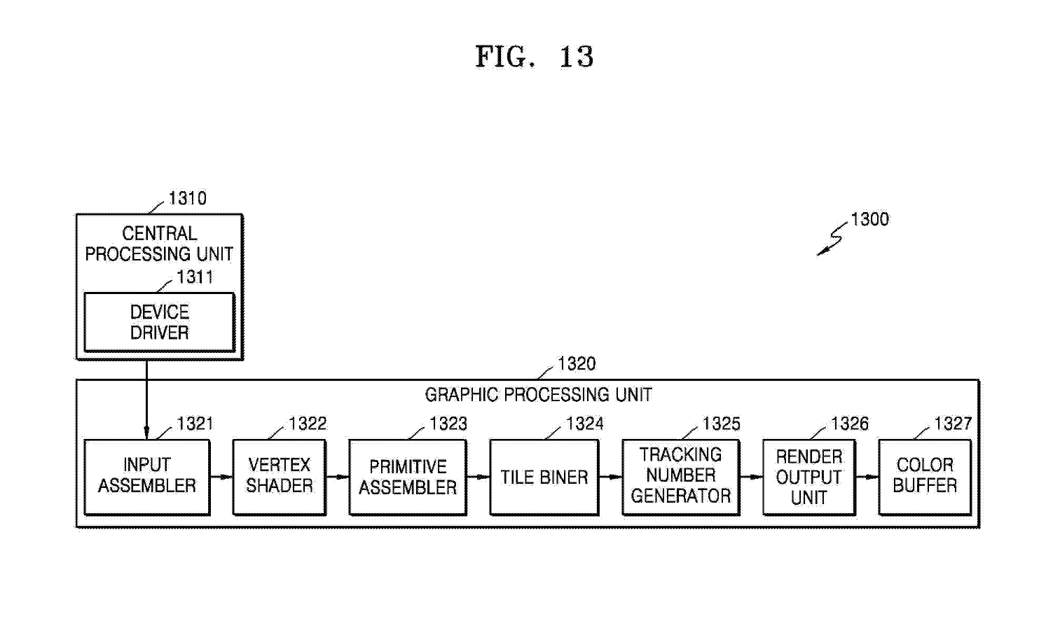

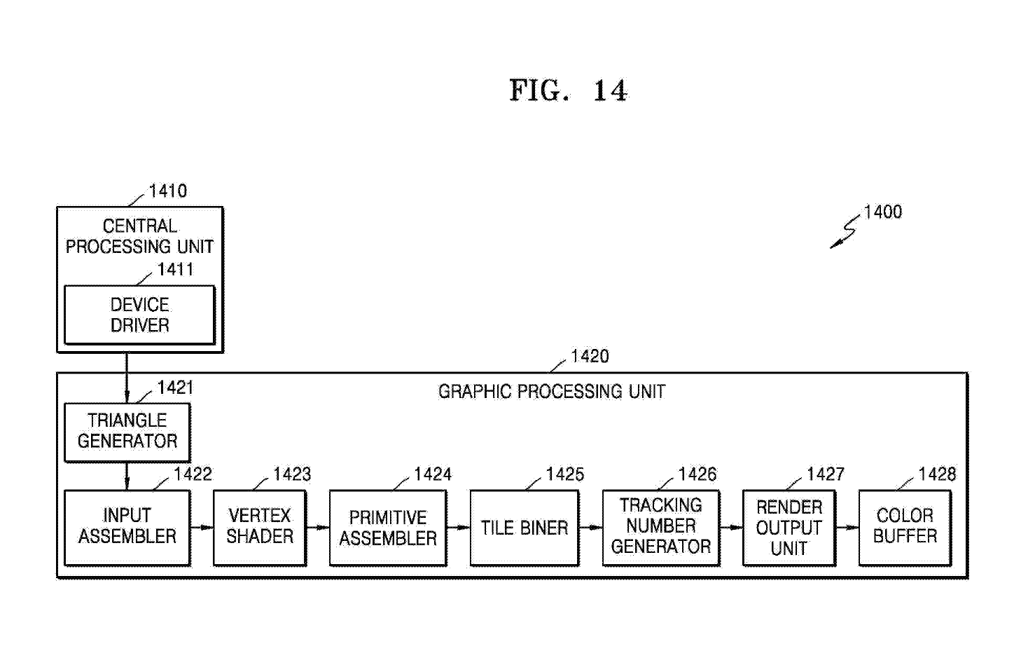

In operation 330, the shading processor 130 shades the pixels corresponding to the curve by using the triangle formed by the formation processor 120. For example, the shading processor 130 calculates a tracking number of each pixel based on the triangle and may set colors of the pixels based on the calculated number of pixels. Detailed examples of operations of the shading processor 130 will be described with reference to FIGS. 13 and 14.

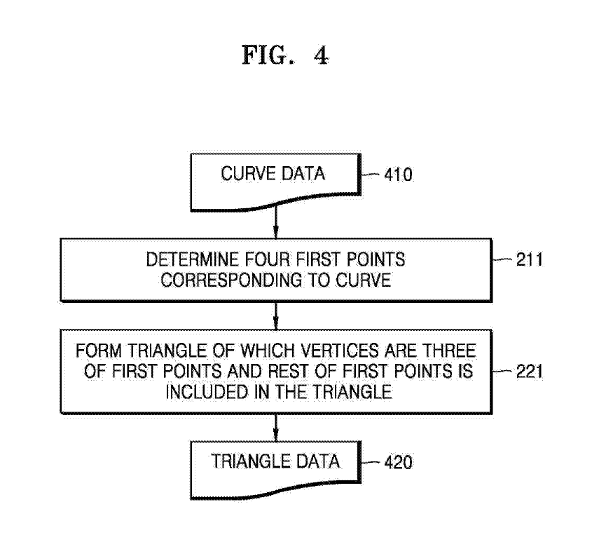

As described above, the determination processor 110 may adaptively determine points according to the shape of the curve, and the formation processor 120 may form the triangle based on the order and the locations of the points. Hereinafter, operations of the determination processor 110 and the formation processor 120 according to various shapes of the curve will be described with reference to FIGS. 4 to 12.

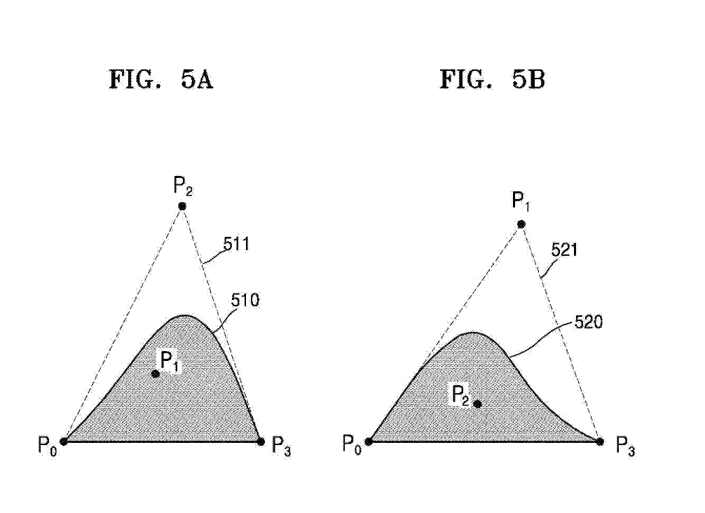

FIGS. 4 to 5B illustrate an operation of a determination processor 110 and a formation processor 120 according to an example of a rendering device.

According to the shape of the curve, any one of four control points may be positioned within a triangle formed by the other three control points. For example, a control point P1 of a curve 510 illustrated in FIG. 5A is positioned inside a triangle 511 having other control points P0, P2, and P3 as vertices. Also, a control point P2 of a curve 520 illustrated in FIG. 5B is positioned inside a triangle 521 having other control points P0, P1, and P3 as vertices.

FIG. 4 illustrates a flowchart of operations of the determination processor 110 and the formation processor 120 when a shape of a curve included in curve data 410 is the same as shapes of the curves 510 and 520 of FIGS. 5A and 5B.

In operation 211, the determination processor 110 determines four first points corresponding to the curve. The first points indicate control points of the curve. For example, the determination processor 110 may acquire a coordinate indicating a location of each control point of the curve by using information included in the curve data 410.

In operation 221, the formation processor 120 forms a triangle having three of the first points as vertices such that the other of the first points is included in the triangle. Triangle data 420 including information about the triangle is stored in a buffer (not shown). For example, since the determination processor 110 may acquire a coordinate of each control point, the formation processor 120 may form a triangle including any one of the control points therein by comparing the coordinates of the control points with each other.

Hereinafter, an operation example of the determination processor 110 and the formation processor 120 is described with reference to FIGS. 5A and 5B.

Referring to FIG. 5A, the determination processor 110 determines control points P0, P1, P2, and P3 of a curve 510 by referring to the curve data 410. For example, the determination processor 110 may acquire coordinates of the control points P0, P1, P2, and P3. In this case, the control points P0, P1, P2, and P3 has a fixed order. In other words, the control points P0, P1, P2, and P3 may be located in an ascending order from P0 to P3 such that the curve 510 may be formed.

The formation processor 120 forms a triangle 511 by comparing the coordinates of the control points P0, P1, P2, and P3. In detail, the formation processor 120 may form the triangle 511 including the control point P1 therein. Vertices of the triangle 511 are control points P0, P2, and P3.

Referring to FIG. 5B, the determination processor 110 determines control points P0, P1, P2, and P3 of a curve 520 by referring to the curve data 410. In this case, in the same manner as described with reference to FIG. 5A, the determination processor 110 acquires the coordinates of the control points P0, P1, P2, and P3 and the control points P0, P1, P2, and P3 are in a fixed order.

The formation processor 120 forms a triangle 521 by comparing the coordinates of the control points P0, P1, P2, and P3. In detail, the formation processor 120 may form the triangle 521 including the control point P2 therein. Vertices of the triangle 521 are the control points P0, P1, and P3.

As described above with reference to FIGS. 5A and 5B, the curves 510 and 520 are fully included in the triangles 511 and 521. Therefore, the rendering device 100 may perform rendering of the curves 510 and 520 without dividing the curves 510 and 520 into sub-curves.

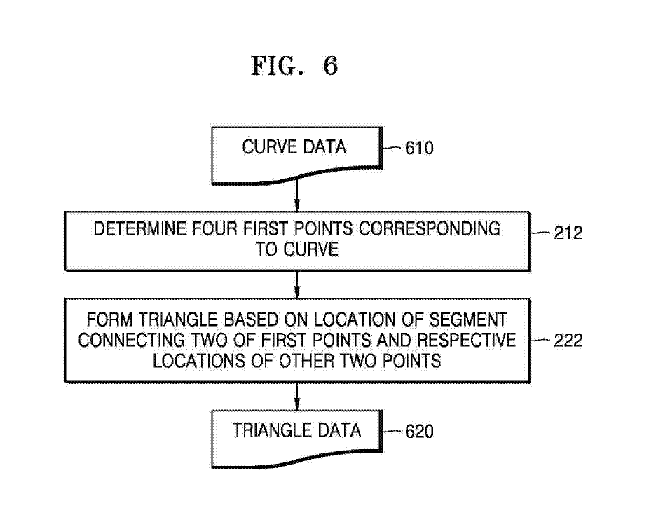

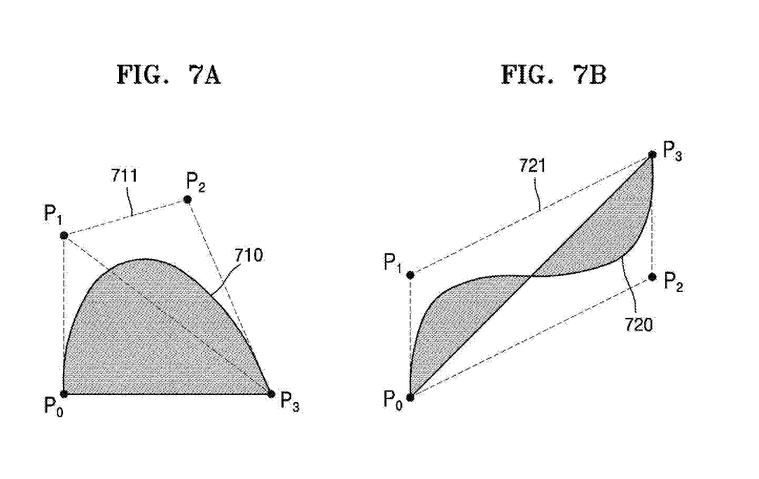

FIGS. 6 to 7B illustrate another operation example of the determination processor 100 and the formation processor 120.

According to a shape of a curve, the curve may be fully included in a rectangle having four control points as vertices. For example, a curve 710 of FIG. 7A is positioned within a rectangle 711 having control points P0, P1, P2, and P3 as vertices. Also, a curve 720 of FIG. 5B is positioned within a rectangle 721 having control points P0, P1, P2, and P3 as vertices.

FIG. 6 illustrates a flowchart of an operation example of the determination processor 110 and the formation processor 120 when the shape of the curve which is included in curve data 610 are the same as shapes of the curves 710 and 720.

In operation 212, the determination processor 110 determines four first points corresponding to a curve. The first points are control points of the curve. For example, the determination processor 110 may acquire a coordinate indicating a location of each control point of the curve by using information included in the curve data 610.

In operation 222, the formation processor 120 forms a triangle based on a location of a segment connecting two of the first points and respective locations of the other two of the first points. Triangle data 620 including information about a triangle is stored in the buffer (not shown). In detail, the formation processor 120 may compare the location of the segment and the locations of the control points by comparing the coordinates of the control points with each other and may form a triangle by referred to a comparison result.

Hereinafter, an operation example of the determination processor 110 and the formation processor 120 is described with reference to FIGS. 7A and 7B.

Referring to FIG. 7A, the determination processor 110 determines control points P0, P1, P2, and P3 of the curve 710 by referring to the curve data 610. For example, the determination processor 110 may acquire coordinates of the control points P0, P1, P2, and P3. In this case, the features that the determination processor 110 acquires the coordinates of the control points P0, P1, P2, and P3, and that the control points P0, P1, P2, and P3 has a fixed order are the same as described with reference to FIG. 5.

The formation processor 120 forms a segment P0P3 that connects two control points P0 and P3. For example, the control points P0 and P3 may be a start point and an end point of the curve 710.

The formation processor 120 compares locations of the control points P1 and P2 with a location of the segment P0P3. Since the control points P1 and P2 are positioned in an upper portion of the curve 710 based on the location of the segment P0P3, the formation processor 120 determines that the control points P1 and P2 are positioned in the same direction.

Based on a determination result, the formation processor 120 forms two triangles P0P3P1 and P1P3P2. For example, since the control points P1 and P2 are positioned in the same direction, the formation processor 120 may form one of the triangles P0P3P1 and P1P3P2, that is, the triangle P0P3P1, having the segment P0P3 as a side thereof and may not form the other one of the triangles P0P3P1 and P1P3P2, that is, the triangle P1P3P2, having the segment P0P3 as a side thereof.

Referring to FIG. 7B, the determination processor 110 determines the control points P0, P1, P2, and P3 of the curve 720 by referring to the curve data 610. In this case, the features that the determination processor 110 acquires the coordinates of the control points P0, P1, P2, and P3, and that the control points P0, P1, P2, and P3 has a fixed order are the same as described with reference to FIG. 5A.

The formation processor 120 forms a segment connecting two control points P0 and P3. For example, the control points P0 and P3 may be start and end points of the curve 720.

The formation processor 120 compares locations of the control points P1 and P2 with the location of the segment P0P3. The control point P1 is positioned above the segment P0P3 based on the location of the segment P0P3, and the control point P2 is positioned under the segment P0P3. Therefore, the formation processor 120 determines that the control points P1 and P2 are positioned in different directions.

The formation processor 120 forms two triangles P0P3P1 and P0P3P2 based on a determination result. For example, since the control points P1 and P2 are positioned in different directions, the formation processor 120 may form the triangles P0P3P1 and P0P3P2 to have the segment P0P3 as an edge.

In FIG. 7A, the curve 710 is fully included in the rectangle 711 in which the triangles P0P3P1 and P0P3P2 are combined. In FIG. 7B, the curve 720 is fully included in the rectangle 721 in which the triangles P0P3P1 and P0P3P2 are combined. Therefore, the rendering device 100 may perform rendering of the curves 710 and 720 without dividing the curves 710 and 720 into sub-curves.

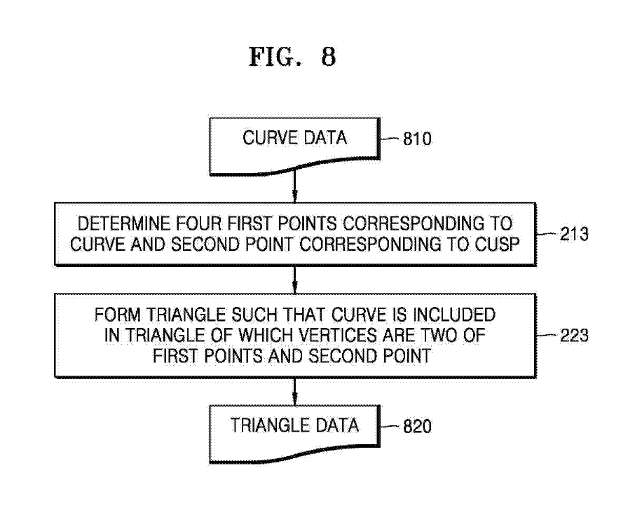

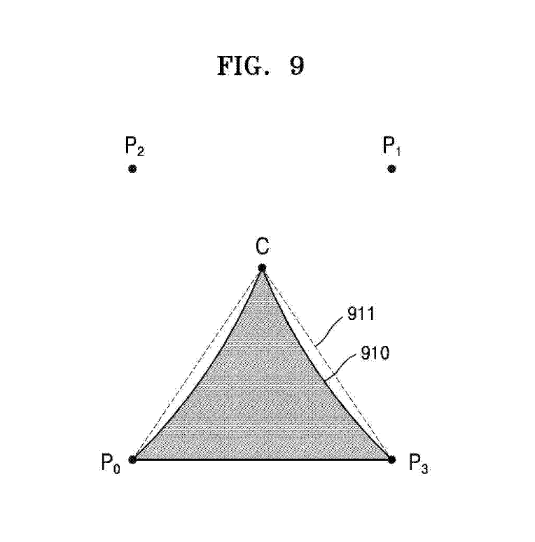

FIGS. 8 and 9 illustrate another operation example of the determination processor 110 and the formation processor 120.

According to one example, a shape of a curve may include a cusp. For example, a curve 910 of FIG. 9 includes a cusp C. That is, the curve 910 may include a cusp C according to locations of the control points P0, P1, P2, and P3.

FIG. 8 illustrates a flowchart of an operation example of the determination processor 110 and the formation processor 120 when the shape of the curve included in the curve data 810 is the same as a shape of the curve 910 of FIG. 9.

In operation 213, the determination processor 110 determines four first points corresponding to the curve 910 and a second point corresponding to the cusp C. The first points are control points of the curve 910. For example, the determination processor 110 may acquire a coordinate of a location of each control point by using information included in the curve data 610.

The determination processor 110 calculates a coordinate of the cusp C by using the coordinates of the control points. For example, the determination processor 110 may calculate the coordinate of the cusp C based on Equations 2 to 4 below.

$${d}_{0} = det [ \begin{matrix}{x}_{3} & {y}_{3} & {w}_{3} \\ {x}_{2} & {y}_{2} & {w}_{2} \\ {x}_{1} & {y}_{1} & {w}_{1}\end{matrix} ] , \\ {d}_{1} = - det [ \begin{matrix}{x}_{3} & {y}_{3} & {w}_{3} \\ {x}_{2} & {y}_{2} & {w}_{2} \\ {x}_{0} & {y}_{0} & {w}_{0}\end{matrix} ] , \\ {d}_{2} = det [ \begin{matrix}{x}_{3} & {y}_{3} & {w}_{3} \\ {x}_{1} & {y}_{1} & {w}_{1} \\ {x}_{0} & {y}_{0} & {w}_{0}\end{matrix} ] , \\ {d}_{3} = - det [ \begin{matrix}{x}_{2} & {y}_{2} & {w}_{2} \\ {x}_{1} & {y}_{1} & {w}_{1} \\ {x}_{0} & {y}_{0} & {w}_{0}\end{matrix} ] . \qquad [ Equation 2 ]$$

In Equation 2 above, d0, d1, d2, and d3 are elements of a vector D necessary to determine a coordinate of a second point. Also, it is assumed that a coordinate of control point P0 is (x0, y0, w0), a coordinate of control point P1 is (x1, y1, w1), a coordinate of control point P2 is (x2, y2, w2), and a coordinate of control point P3 is (x3, y3, w3).

According to Equation 2, after d0, d1, d2, and d3 are calculated, it is determined whether the determination processor 110 satisfies a condition of Equation 3 below.

d₁≠0 and 3d₂²−4d₁d₃=0 [Equation 3]

When the condition of Equation 3 is satisfied, the determination processor 110 calculates a coordinate of a cusp C based on Equation 4 below.

(t_{d}, s_{d})=(d₂, 2d₁), [Equation 4]

t=t_{d}/s_{d}

In Equation 4 above, (t_{d}, s_{d}) indicates a coordinate of the cusp C, and t is a variable written in Equation 1.

In operation 223, the formation processor 120 forms a triangle having two of four first points and a second point as vertices such that a curve is included in the triangle. For example, the formation processor 120 may from a triangle having a control point corresponding to a staring vertex of the curve, a control point corresponding to an end point of the curve, and a cusp are vertices.

Hereinafter, examples of operations of the determination processor 110 and the formation processor 120 will be described with reference to FIG. 9.

Referring to FIG. 9, the determination processor 110 determines control points P0, P1, P2, and P3 of a curve 910 by referring to the curve data 810. For example, the determination processor 110 may acquire coordinates of the control points P0, P1, P2, and P3. In this case, the features of the determination processor 110 for acquiring the coordinates of the control points P0, P1, P2, and P3 and the control points P0, P1, P2, and P3 having a fixed order are the same as described with reference to FIG. 5A. The determination processor 110 calculates a coordinate of the cusp C based on Equations 2 to 4 described above.

The formation processor 120 forms a triangle 911 having two control points P0 and P3 and the cusp C as vertices. For example, the control points P0 and P3 may be start and end points of the curve 910.

As described above with reference to FIG. 9, the curve 910 is fully included inside the triangle 911. Therefore, the rendering device 100 may perform rendering of the curve 910 without dividing the curve 910 into sub-curves.

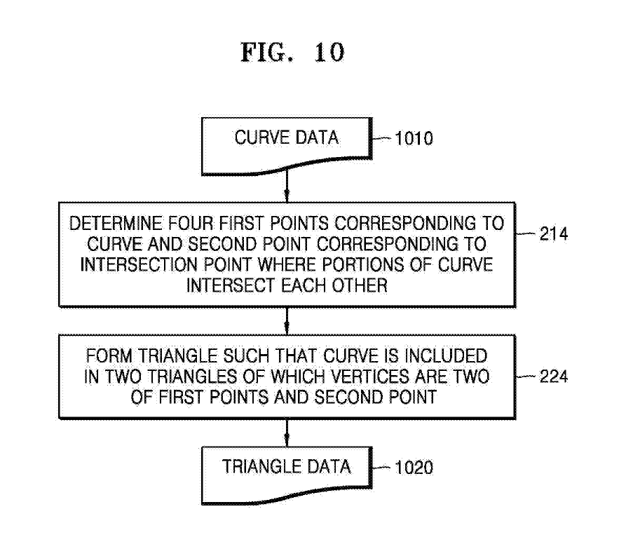

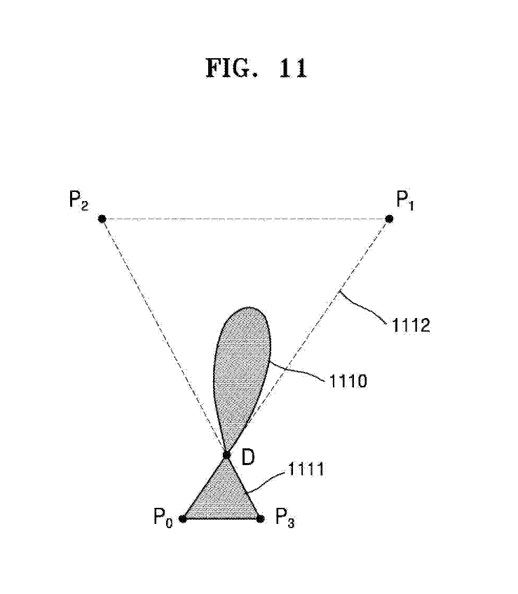

FIGS. 10 and 11 illustrate another operation example of the determination processor 110 and the formation processor 120.

According to a shape of a curve 1110, the curve 1110 may include a loop. For example, the curve 1110 of FIG. 11 includes a loop including an intersection point D. In other words, the curve 1110 may include the loop according to locations of control points P0, P1, P2, and P3 of the curve 1110.

FIG. 10 illustrates a flowchart of an operation of the determination processor 110 and the formation processor 120 when a shape of a curve included in curve data 1010 is the same as the shape of the curve 1110 of FIG. 11.

In operation 214, the determination processor 110 determines four first points corresponding to the curve and a second point corresponding to an intersection point where portions of the curve intersect each other. The first points are control points of the curve. For example, the determination processor 110 may acquire a coordinate indicating a location of each control point of the curve by using information included in the curve data 1010.

The determination processor 110 calculates a coordinate of the intersection point by using the coordinates of the control points. For example, the determination processor 110 may calculate the coordinate of the intersection point based on Equation 2 above and Equations 5 and 6 below.

After d0, d1, d2, and d3 are calculated according to Equation 2, the determination processor 110 determines whether a condition of Equation 5 is satisfied.

d₁≠0 and 3d₂²−4d₁d₃<0 [Equation 5]

When the condition of Equation 5 is satisfied, the determination processor 110 calculates a coordinate of the intersection point D based on Equation 6.

(t_{d}, s_{d})=(d₂+\sqrt{4d₁d₃−3d₂²}, 2d₁), [Equation 6]

t=t_{d}/s_{d}

In Equation 6, (t_{d}, s_{d}) indicates the coordinate of the intersection point D, and t is a variable written in Equation 1.

In operation 223, the formation processor 120 forms two triangles having two of the first points and the second point as vertices such that the curve is included in the triangles. For example, the formation processor 120 may form a first triangle having a control point corresponding to a start point of the curve, a control point corresponding to an end point, and the intersection point D as vertices and a second triangle having the other of the control points and the intersection point D as vertices.

Hereinafter, an operation of the determination processor 110 and the formation processor 120 will be described with reference to FIG. 11.

Referring to FIG. 11, the determination processor 110 determines control points P0, P1, P2, and P3 of the curve 1110 by referring to the curve data 1010. For example, the determination processor 110 may acquire coordinates of the control points P0, P1, P2, and P3. In this case, the features that the determination processor 110 acquires the coordinates of the control points P0, P1, P2, and P3 and that the control points P0, P1, P2, and P3 has a fixed order are the same as described with reference to FIG. 5A. The determination processor 110 calculates the coordinate of the intersection point D based on Equations 2, 5 and 6.

The formation processor 120 forms a first triangle 1111 having two control points P0 and P3 and the intersection point D as vertices. The control points P0 and P3 may be start and end points of the curve 1110. Also, the formation processor 120 forms a second triangle 1112 having the other two of the control points P1 and P2 and the intersection point D as vertices.

As described above with reference to FIG. 11, the curve 1110 is fully included in the first and second triangles 1111 and 1112. Therefore, the rendering device 100 may perform rendering of the curve 1110 without dividing the curve 1110 into sub-curves.

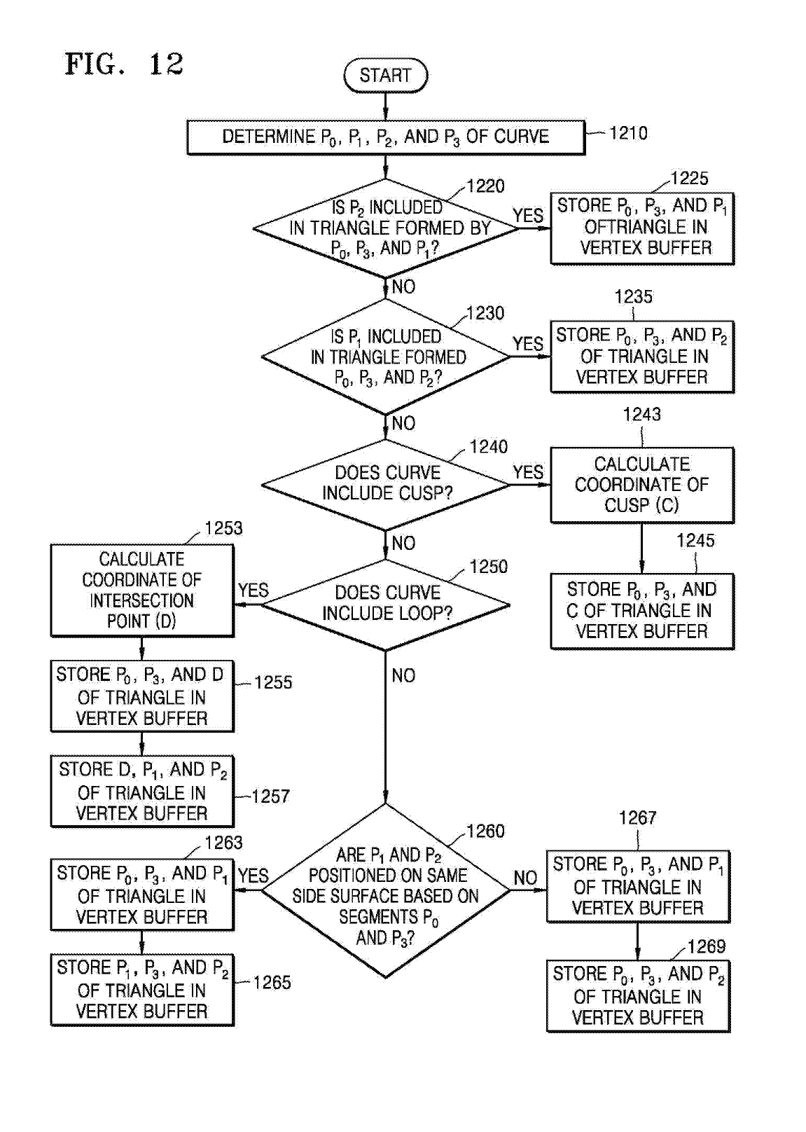

As described above with reference to FIGS. 4 to 11, the rendering device 100 may adaptively form a triangle based on various shapes of a curve. Hereinafter, a process regarding the examples described with reference to FIGS. 4 to 11 will be described with reference to FIG. 12.

FIG. 12 illustrates a flowchart of another example operation of the determination processor 110 and the formation processor 120.

The flowchart of FIG. 12 includes operation examples of the determination processor 110 and the formation processor 120 which are described with reference to FIGS. 4 to 11. Therefore, although omitted, the descriptions provided with reference to FIGS. 4 to 11 may be applied to the flowchart of FIG. 12.

In operation 1210, the rendering device 100 determines control points P0, P1, P2, and P3 of a curve. In detail, the rendering device 100 may acquire coordinates of the control points P0, P1, P2, and P3 based on curve data. The control point P0 corresponds to a start point of the curve, and the control point P3 corresponds to an end point of the curve.

In operation 1220, the rendering device 100 determines whether the control point P2 is included in a triangle P0P3P1. In detail, the rendering device 100 forms the triangle P0P3P1 having three control points P0, P1, P3 as vertices and determines whether the control point P2 is included in the triangle P0P3P1.

If the control point P2 is included in the triangle P0P3P1, operation 1225 is performed, and if the control point P2 is not included in the triangle P0P3P1, operation 1230 is performed.

In operation 1225, the rendering device 100 stores the triangle P0P3P1 in a vertex buffer (not shown). For example, the rendering device 100 may store, in the vertex buffer, triangle data including information about the triangle P0P3P1.

In operation 1230, the rendering device 100 determines whether the control point P1 is included in a triangle P0P3P2. In detail, the rendering device 100 forms the triangle P0P3P2 having three control points P0, P2, and P3 as vertices and may determine whether the control point P1 is included in the triangle P0P3P2.

If the control point P1 is included in the triangle P0P3P2, operation 1235 is performed, and if the control point P1 is not included in the triangle P0P3P2, operation 1240 is performed.

In operation 1235, the rendering device 100 stores the triangle P0P3P2 in the vertex buffer. For example, the rendering device 100 may store, in the vertex buffer, triangle data including information about the triangle P0P3P2.

In operation 1240, the rendering device 100 determines whether the curve includes a cusp. For example, the rendering device 100 may determine whether the curve includes the cusp, based on Equations 2 and 3.

If the curve includes the cusp, operation 1243 is performed, and if the curve does not include the cusp, operation 1250 is performed.

In operation 1243, the rendering device 100 calculates a coordinate of the cusp C. For example, the rendering device 100 may calculate the coordinate of the cusp C based on Equation 4.

In operation 1245, the rendering device 100 stores a triangle P0P3C in the vertex buffer. In detail, the rendering device 100 forms the triangle P0P3C having three points P0, P3, and C as vertices and may store, in the vertex buffer, triangle data including information about the triangle P0P3C.

In operation 1250, the rendering device 100 determines whether the curve includes a loop. For example, the rendering device 100 may determine whether the curve includes the loop, based on Equations 2 and 5.

If the curve includes the loop, operation 1253 is performed, and if the curve does not include the loop, operation 1260 is performed.

In operation 1253, the rendering device 100 calculates a coordinate of an intersection point D. For example, the rendering device 100 may calculate the coordinate of an intersection point D based on Equation 6.

In operations 1255 and 1257, the rendering device 100 may store a first triangle P0P3D and a second triangle DP1P2 in the vertex buffer (not shown). In detail, the rendering device 100 forms the first triangle P0P3D and the second triangle DP1P2 and may store, in the vertex buffer, triangle data including information about the first triangle P0P3D and the second triangle DP1P2.

In operation 1260, the rendering device 100 determines whether the control points P1 and P2 are positioned in the same direction, based on a segment P0P3. In detail, the rendering device 100 forms the segment P0P3 connecting the control point P0 corresponding to a start point of the curve and the control point P3 corresponding to an end point of the curve. The rendering device 100 determines whether the control points P1 and P2 are positioned in the same direction, based on a segment P0P3.

If it is determined that the control points P1 and P2 are positioned in the same direction, operation 1263 is performed, and if it is determined that the control points P1 and P2 are positioned in different directions, operation 1267 is performed.

In operations 1263 and 1265, the rendering device 100 stores the first triangle P0P3D and the second triangle DP1P2 in the vertex buffer. In detail, the rendering device 100 forms the first triangle P0P3D and the second triangle DP1P2 and may store, in the vertex buffer, the triangle data including the information about the first triangle P0P3D and the second triangle DP1P2.

In operations 1267 and 1269, the rendering device 100 stores a third triangle P0P3P1 and a fourth triangle P0P3P2 in the vertex buffer. In detail, the rendering device 100 forms the third triangle P0P3P1 and the fourth triangle P0P3P2 and may store, in the vertex buffer, triangle data including information about the third triangle P0P3P1 and the fourth triangle P0P3P2.

FIG. 13 illustrates a diagram of an example of a rendering apparatus 1300.

Referring to FIG. 13, the rendering apparatus 1300 includes a central processing unit (CPU) 1310 and a graphics processing unit (GPU) 1320. The CPU 1310 and GPU 1320 are hardware devices including hardware structures such as specialized electronic circuits and memory. The CPU 1310 may include a device driver 1311, and the GPU 1320 may include modules 1321, 1322, 1323, 1324, 1325, 1326, and 1327 used to perform rendering of a curve.

The operations of the determination processor 110 and the formation processor 120 described with reference to FIGS. 1 to 12 may be performed by the CPU 1310 of FIG. 13. In other words, the device driver 1311 determines a plurality of points based on a shape of the curve. The device driver 1311 forms at least one triangle based on a location relationship between the points. The device driver 1311 stores, in the vertex buffer, triangle data including information about a triangle.

For example, the CPU 1310 may generate curve data via an application program, and the device driver 1311 may generate a command such that the GPU 1320 may perform the rendering of the curve.

The operations of the shading processor 130 described with reference to FIGS. 1 to 12 may be performed by the GPU 1320 of FIG. 13. In other words, the GPU 1320 shades pixels corresponding to the curve by using the triangle data stored in the vertex buffer.

For example, the GPU 1320 calculates the tracking number of each pixel corresponding to the curve and may set colors of the pixels based on the calculated tracking number. Also, the GPU 1320 divides a frame into tiles and may perform tile binning.

First of all, the GPU 1320 may select tiles including a triangle from among the tiles included in the frame. The triangle indicates a triangle formed by the CPU 1310. The triangle may be divided into three edges. In other words, the triangle may be divided into three edges based on points corresponding to vertices. Therefore, the GPU 1320 may select tiles respectively including the edges from among the tiles included in the frame.

Then, the GPU 1320 assigns an identification value of the curve to each of the selected tiles. Also, the GPU 1320 assigns (generates a Curve_List) an identification value of the curve to tiles aligned on a side of the selected tiles in a direction. The direction may indicate a right-side direction, but the inventive concept is not limited thereto.

Hereinafter, operations of the modules 1321, 1322, 1323, 1324, 1325, 1326, and 1327 included in the GPU 1320 will be described.

An input assembler 1321 reads, from a memory, data regarding at least one point on a path and transmits the read data to a vertex shader 1322. The vertex shader 1322 performs a vertex shading code written by a user about points. In other words, the vertex shader 1322 interprets a command indicating the curve. For example, a shading core of the GPU 1320 may perform functions of the vertex shader 1322.

A primitive assembler 1323 forms a primitive by collecting points that pass the vertex shader 1322. The primitive is a path formed by the points and means an element forming an object. The primitive according to an embodiment includes a curve.

A tile binner 1324 performs tile binning. For example, the tile binner 1324 may assign an identification value of the curve to the tiles included in the frame. For example, the tile binner 1324 may generate a list including a name of the primitive (curve) for each tile, and the primitive is to be processed when rendering of the tiles is performed. Hereinafter, the list including the name of the curve will be referred to as ‘Curve_List’.

The tiles are defined as a group of pixels included in a frame. For example, if it is assumed that 1024*768 pixels are included in the frame and the frame is divided into four tiles, one tile includes 512*384 pixels.

The identification value of the curve indicates the curve, and the curve may have a predetermined name. If a value indicates a certain curve and is predetermined, the value may correspond to the identification value.

Also, the tile binner 1324 may calculate the initial tracking number of each tile based on a location of the curve and a moving direction thereof. If the tile binner 1324 does not calculate the initial tracking number of each tile, a tracking number generator 1325 may calculate the initial tracking number.

The tracking number generator 1325 may calculate the initial tracking number of pixels included in each tile based on the location of the curve and the moving direction thereof. For example, the tracking number generator 1325 may be implemented as hardware or software executed in the shading core.

FIG. 13 illustrates that the GPU 1320 includes the tracking number generator 1325, but the inventive concept is not limited thereto. In other words, the tracking number generator 1325 may be a single device separated from the GPU 1320. For example, a separate tracking number generator (not shown) receives, from the GPU 1320, information about a coordinate of each point included in the curve and information about coordinates of the pixels included in the frame. The separate tracking number generator calculates the tracking number of pixels by using the received pieces of information and returns the calculated tracking number to the GPU 1320.

In other words, the tracking number of pixels may be calculated by the shading core included in the GPU 1320 or by hardware separated from the GPU 1320.

A render output unit 1326 records, on a color buffer 1327, data (e.g., information about colors of the pixels) generated as a pixel shader (not shown) operates. In other words, the pixel shader determines a color of each pixel included in the frame, and the render output unit 1326 records, on the color buffer 1327, the information about the colors of the pixels by merging pieces of the information about the colors of the pixels. The render output unit 1326 may be referred to as a module for a raster operations pipeline, and includes hardware structures such as a processor and a memory.

For example, the pixel shader receives information about the pixels included in the frame and may determine a color of each pixel. In other words, the pixel shader performs shading of the pixels based on the tracking number of each pixel. The shading may be a process of setting a color of each pixel, but the inventive concept is not limited thereto. For example, the shading may be a process of setting a contrast of each pixel or a process of indicating a texture of each pixel. Also, the pixel shader may perform shading of pixels based on the textures thereof. For example, the pixel shader may determine colors of the pixels based on predetermined standards.

The render output unit 1326 records information about the colors of the pixels on the buffer 1327. While an example in which the render output unit 1326 is decoupled from the pixel shader, in another example, the render output unit and the pixel shader may be combined into one module.

FIG. 14 illustrates a block diagram of another example of a rendering apparatus 1400.

When the rendering apparatus 1400 of FIG. 14 is compared with the rendering apparatus 1300 of FIG. 13, a triangle generator 1421 is further included in the GPU 1420. In other words, the triangle generator 1421 of the GPU 1420 may perform a process of forming a triangle, which has been previously performed by the device driver 1311 of FIG. 13, instead of a device driver 1411 of FIG. 14.

Examples of operations of the device driver 1411 of FIG. 14 are the same as examples of operations of the device driver 1311 of FIG. 13, except that the device driver 1411 does not performs the process of forming the triangle. Hereinafter, therefore, detailed descriptions of the CPU 1410 and the device driver 1411 will be omitted.

Examples of operations of the modules 1422, 1423, 1424, 1425, 1426, 1427, and 1428 included in the GPU 1420 are the same as the examples of the operations of the modules 1321, 1322, 1323, 1324, 1325, 1326, and 1327 included in the GPU 1320. Therefore, hereinafter, a detailed description of the GPU 1420 will be omitted.

As described above, the rendering device 100 may adaptively form a triangle based on various shapes of the curve. Therefore, since the rendering device 100 may perform curve rendering without dividing the curve into sub-curves, an operation amount required to perform the curve rendering may be reduced, and a high-quality rendering result may be output.

The apparatuses, units, modules, devices, and other components illustrated in FIGS. 1, 13 and 14 that perform the operations described herein with respect to FIGS. 3, 4 and 6 are implemented by hardware components. Examples of the hardware components include controllers, sensors, generators, drivers, memories, comparators, arithmetic logic units, adders, subtractors, multipliers, dividers, integrators, and any other electronic components known to one of ordinary skill in the art. In one example, the hardware components are implemented by computing hardware, for example, by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein with respect to FIGS. 1-14. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 3, 4, 6, 8, 10 and 12 that perform the operations described herein with respect to FIGS. 2A-2D, 5A, 5B, 7A, 7B, 9 and 11 are performed by a processor or a computer as described above executing instructions or software to perform the operations described herein.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD−ROMs, CD−Rs, CD+Rs, CD−RWs, CD+RWs, DVD−ROMs, DVD−Rs, DVD+Rs, DVD−RWs, DVD+RWs, DVD−RAMs, BD−ROMs, BD−Rs, BD−R LTHs, BD−REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of performing curve rendering, the method comprising:
determining a plurality of points based on a shape of a curve by using a processor;
forming at least one triangle based on a location relationship between the plurality of points; and
shading pixels corresponding to the curve by using the at least one triangle,
wherein the plurality of points are vertices of the at least one triangle.

2. The method of claim 1, wherein the plurality of points comprise first points corresponding to the curve and a second point calculated based on the first points.

3. The method of claim 1, wherein the curve comprises a cubic Bézier curve;
in the determining of the plurality of points, four first points corresponding to the cubic Bézier curve are determined as the plurality of points; and
in the forming of the at least one triangle, three of the four first points are vertices of the at least one triangle, and the other of the four first points is positioned within the at least one triangle.

4. The method of claim 1, wherein the curve comprises a cubic Bézier curve;
in the determining of the plurality of points, four first points corresponding to the cubic Bézier curve are determined as the plurality of points; and
in the forming of the at least one triangle, the at least one triangle is formed based on a location of a segment connecting two of the four first points and respective locations of the other two of the four first points.

5. The method of claim 1, wherein the curve comprises a curve comprising a cusp;
in the determining of the plurality of points, four first points corresponding to the curve comprising the cusp and a second point corresponding to the cusp are determined as the plurality of points; and
in the forming of the at least one triangle, the curve comprising the cusp is positioned within a triangle of which vertices are two of the four first points and the second point.

6. The method of claim 1, wherein the curve comprises a curve comprising a loop;
in the determining of the plurality of points, four first points corresponding to the curve comprising the loop and a second point corresponding to an intersection point where portions of the curve comprising the loop intersect are determined; and
in the forming of the at least one triangle, the curve comprising the loop is positioned within a triangle of which vertices are two of the four first points and the second point.

7. The method of claim 1, wherein the shading of the pixels comprises setting colors of the pixels corresponding to an inside area of the curve from among pixels comprised in the at least one triangle.

8. A non-transitory computer-readable storage medium storing instructions to cause computing hardware to perform the method of claim 1.

9. A device for performing curve rendering, the device comprising:
a determination processor configured to determine a plurality of points based on a shape of a curve;
a formation processor configured to form at least one triangle based on a location relationship between the plurality of points; and
a shading processor configured to shade a plurality of pixels corresponding to the curve based on the at least one triangle,
wherein the plurality of points are vertices of the at least one triangle.

10. The device of claim 9, wherein the plurality of points comprise first points corresponding to the curve or a second point calculated based on the first points.

11. The device of claim 9, wherein the curve comprises a cubic Bézier curve;
the determination processor is configured to determine four first points corresponding to the cubic Bézier curve; and
the formation processor is configured to form the at least one triangle of which vertices are three of the four first points, and the other of the four first points is positioned within the at least one triangle.

12. The device of claim 9, wherein the curve comprises a cubic Bézier curve,
the determination processor is configured to determine four first points corresponding to the cubic Bézier curve, and
the formation processor is configured to form the at least one triangle based on a location of a segment connecting two of the four first points and respective locations of the other two of the four first points.

13. The device of claim 9, wherein the curve comprises a curve comprising a cusp,
the determination processor is configured to determine four first points corresponding to the curve comprising the cusp and a second point corresponding to the cusp, and
the formation processor is configured to form a triangle of which vertices are two of the four first points and the second point such that the curve comprising the cusp is positioned within the triangle.

14. The device of claim 9, wherein the curve comprises a curve comprising a loop;
the determination processor is configured to determine four first points corresponding to the curve comprising the loop and a second point corresponding to an intersection point where portions of the curve comprising the loop intersect; and
the formation processor is configured to form two triangles of which vertices are two of the four first points and the second point such that the curve comprising the loop is positioned within the two triangles, wherein the two of the four points are different for each of the triangles.

15. The device of claim 9, further comprising a shading unit configured to set colors of pixels corresponding to an inside area of the curve from among pixels in the at least one triangle.

16. An apparatus for performing curve rendering, the apparatus comprising:
a central processing unit (CPU) configured to determine a plurality of points based on a shape of a curve and form at least one triangle based on a location relationship between the plurality of points; and
a graphics processing unit (GPU) configured to shade pixels corresponding to the curve based on the at least one triangle,
wherein the plurality of points are vertices of at least one triangle.

17. An apparatus for performing curve rendering, the apparatus comprising:
a central processing unit (CPU) configured to determine a plurality of points based on a shape of a curve and generate data corresponding to at least one triangle based on a location relationship between the plurality of points; and
a graphics processing unit (GPU) configured to form the at least one triangle by using the generated data and shade a plurality of pixels corresponding to the curve by using the at least one triangle,
wherein the plurality of points are vertices of the at last one triangle.
